(19) United States
(12) Patent Application Publication
(10) Pub. No.: US 2012/0107609 A1
(43) Pub. Date: May 3, 2012

(54) SOLAR MIRROR FILM COMPOSITE HAVING PARTICULARLY HIGH WEATHERING AND UV STABILITY

(75) Inventors: Uwe Numrich, Gross-Zimmern (DE); Achim Neuhäuser, Mainz (DE); Werner Arnold, Schaafheim (DE); Michael Olbrich, Karlstein (DE)

(73) Assignee: Evonik Degussa GmbH, Essen (DE)

(21) Appl. No.: 13/382,577

(22) PCT Filed: May 17, 2010
(86) PCT No.: PCT/EP2010/056680

§ 371 Date: Jan. 6, 2012

(30) Foreign Application Priority Data
Jul. 31, 2009 (DE) 10 2009 028 168.1

(51) Int. Cl. C09J 7/02; B32B 37/12; B32B 37/10; B32B 15/04; B32B 15/08

(52) U.S. Cl. 428/344; 156/60

(57) ABSTRACT

The invention relates to a film composite and the use thereof as a mirror film in solar reflectors in view of the sustainable guarantee of the required reflection of solar radiation (total solar reflection). In particular, the invention relates to the use of cover films on the basis of polymethyl methacrylate (PMMA) in the film composite, having an especially high UV stability, and a high weathering stability. The invention further relates to a UV and weather protection package for said solar mirror film, as utilized in solar reflectors, for improving the optical life span, weathering stability, and for avoiding delamination. The invention further relates to a surface finish with regard to scratch resistance, anti-soil and chemical stability of the solar mirror film.

### FIELD OF THE INVENTION

The invention relates to a film composite and to its use as reflector film in solar reflectors, in the context of ensuring maximum durability of the required reflection of solar radiation (total solar reflection).

The invention in particular relates to the use of outer films based on polymethyl (meth)acrylate (PMMA) in the film composite, with particularly high UV resistance and high weathering resistance. The invention further relates to a UV- and weathering-stabilizer package for said solar reflector film, as used in solar reflectors, for improving optical lifetime and weathering resistance, and for preventing delamination. The invention further relates to a surface finish relevant to scratch resistance, antisoil properties and chemicals resistance of the solar reflector film.

The expression outer film is synonymous with a surface-finishing layer, surface-finishing film, or the general term surface finish.

### PRIOR ART

Flexible reflector film laminates in solar reflectors of the prior art have disadvantages in respect of adequacy of weathering resistance, and degradation due to ultraviolet (UV) radiation. However, in particular for outdoor applications, stringent requirements are placed upon such films relating to stability and resistance to UV radiation and to other effects of weathering. These demands concern in particular dimensional stability, reflectance in the visible and near-infrared spectrum, and external appearance.

The wavelength spectrum of solar radiation relevant for “solar heating” extends from 300 nm to 2500 nm.

However, filtration should be used to remove the region below 400 nm, in particular below 375 nm, in order to lengthen the lifetime of the solar reflector film, and the remaining “effective wavelength range” is therefore from 375 nm or 400 nm up to 2500 nm.

The reflectance of flexible reflector film laminates in this application is determined by quality and stability. This type of laminate is produced by vacuum-metallization to give a thin silver layer on a flexible polymer film (backing film). Silver is the preferred metal for this application, because its reflectance in the relevant wavelength range is particularly high in comparison with other metals. The polymeric backing film and optionally the silver layer are protected from external effects by an additional protective-layer coating. The purpose of this protective layer, which is generally an outer surface-finishing film, is to provide protection from mechanical abrasion, effects of weathering, and degradation due to UV radiation.

U.S. Pat. No. 4,307,150 describes a protective system of this type for aluminium reflectors. The backing film used comprises a PET laminate which is metallized with aluminium and is protected from corrosion and effects of weathering by using adhesive bonding to apply a (meth)acrylate film. No explicit consideration is given to UV stabilizers. Because of the higher reflectance, metallization with silver is a markedly more suitable option than an aluminium layer in the design of these reflectors. U.S. Pat. No. 4,645,714 describes the use of silver. However, in principle silver has two disadvantages. Firstly, silver layers, particularly if they are thin, are particularly susceptible to corrosion. Protective layers or protective laminates therefore have to be particularly leakproof. Otherwise, small perforations or inadequate leak proofing at the edge of the laminate are sufficient to cause undesired oxidation. Secondly, both silver and aluminium have an absorption gap in the spectral region of ultraviolet light (from 300 to 400 nm), in particular in the region around a wavelength of 320 nm, which is an important constituent of sunlight. This permeability is particularly present in very thin layers. This short-wave radiation is damaging to the backing film and also to the reflector layer of metallic silver, and particularly to the polyester films or polyester laminates that are mostly used, or to the adhesives used for laminate production, especially when exposure is prolonged, as is the case in the solar reflectors sector. The result can be blistering and therefore deformation and reduction of reflectance.

Inhibitors to counter corrosion, and UV-absorption reagents can be introduced into the abovementioned protective film in order to improve the level of protection. However, a disadvantage of most of the inhibitors used is that they themselves have only relatively low weathering resistance or indeed UV resistance, and cause discoloration over the course of time. This discoloration reduces reflection in other spectral regions and thus reduces the effectiveness of the solar installation.

On the other hand, UV absorbers by themselves do not make a contribution to prevention of corrosion of the silver coating: they merely inhibit weathering-related ageing of the polyester laminate. Optimized protection is therefore obtained by separating the two components—inhibitor and UV absorber.

To that end, U.S. Pat. No. 4,645,714 applies two separate (meth)acrylate-based coatings. The outer coating comprises the UV absorber, and the inner coating comprises the inhibitor. By virtue of this structure, the outer layer protects the inner layer, and the extent of discoloration is markedly reduced. The inhibitor layer here is applied directly to the silver metallization. The second layer, comprising the UV absorber, is in turn applied over said first layer. The polyester laminate used comprises a two-layer coextruded PET film, where one of the layers comprises a lubricant to improve flexibility and the other, silver-metallized, layer comprises no lubricant, in order to ensure provision of a surface with maximum smoothness. The inner (meth)acrylate layer comprises from 0.5 to 2.5% by weight of glycol dimercaptoacetate, which acts as dispersing agent, coupling reagent, adhesion promoter and inhibitor.

The outer (meth)acrylate layer comprises a UV-absorption reagent which is active for radiation with a wavelength from 300 nm to 400 nm. Corrosion of the silver by the UV-absorption reagent is moreover excluded by virtue of the two-layer structure.

The uncoated side of the polyester laminate in turn has a coating of a PSA (pressure-sensitive adhesive) based on an isooctyl acrylate-acrylamide copolymer. This coating can, for example, be protected with a silicone-coated polyester film prior to use of the reflector laminate.

However, a disadvantage of both of the (meth)acrylate coatings described in U.S. Pat. No. 4,645,714 and U.S. Pat. No. 4,307,150 is that they have relatively low weathering resistance when used in outdoor applications and therefore in principle have only poor suitability for outdoor solar applications. These coatings have only very poor water-repellency, and are not abrasion-resistant, and have only very limited resistance to humidity. Once the poly(meth)acrylate coating has been eroded, the polyester laminate can then be subject to the type of degradation described. In order to avoid this problem, U.S. Pat. No. 5,118,540 uses adhesive bonding to apply an abrasion-resistant and moisture-resistant film based on fluorocarbon polymers. Both the UV-absorption reagent and the corrosion inhibitor are constituents of the adhesive layer used to bond the film to the metal surface of the metallized polyester backing film. The adhesive layer here can again, by analogy with the double (meth)acrylate coating described above, be composed of two different layers, in order to separate the corrosion inhibitor from the UV-absorption reagent.

However, the UV-absorption reagents used are exclusively benzotriazoles, which have only comparatively “brief” intrinsic stability when exposed to UV radiation, and which—in said application—do not provide effective UV protection for the adhesive layer itself and the bonded metal surface and, respectively, polyester backing film.

In contrast, WO 2007/076282 lists an alternative structure to improve protection of the silver coating. The PET backing film is now not metallized with silver on the surface, but instead on the side facing away from the light. On the other side of the PET film, adhesive bonding is used to apply a protective poly(meth)acrylate film equipped with UV-absorption reagents. The teaching relating to the requirement for provision of durable UV protection is not considered in WO 2007/076282.

A pressure-sensitive adhesive (PSA) can be provided directly on the reverse side of the silver metallization, or an additional copper layer can be metallized onto the silver metallization in order to improve corrosion resistance on the reverse side and in order to improve adhesion of the PSA.

The poly(meth)acrylate film used for UV protection is a Korad® film from SPARTECH PEP. A disadvantage of this film is that the UV absorbers used comprise “benzotriazoles”, which have only comparatively “brief” intrinsic stability when exposed to UV radiation, and which—in said application—do not provide effective UV protection for the adhesive layer and the bonded polyester backing film.

Poly(meth)acrylate films which are similar to or analogous to the Korad films have become established in use as surface-protection films for plastics mouldings for various outdoor applications, e.g. in the commercial vehicle sector. However, the performance of this type of outer film is not adequate to provide the required long-term weathering resistance in the reflector film application for solar reflectors, involving maintenance of high solar reflectance.

The prior art provides no teaching concerning production of an outer film with durable UV-protection function appropriate to the durability requirements and reliability requirements placed upon solar reflectors.

In the film laminates marketed hitherto for solar reflectors, the only UV absorbers introduced into the outer film for stabilization with respect to UV radiation are of benzotriazole type. These UV absorbers are marketed by way of example with trade mark Tinuvin 234 by Ciba Specialty Chemicals Inc. It is known that these UV absorbers undergo significant losses of effectiveness over a period of from 5 to 10 years, the result being degradation of the surface-finishing layer. This results in a marked decrease in the solar reflection provided by the solar reflector film composite.

There is an increasing requirement for solar reflector films which markedly exceed the existing requirements placed upon the durability, or maintenance of performance, of the established solar reflector films.

### OBJECT

An object was to provide a novel solar reflector film composite for solar reflectors with, in comparison with the prior art, improved or at least equivalent optical properties, and improved weathering resistance, in particular in respect of long-term use.

Long-term use here is in particular use over a period of more than 10 years, in particular more than 15 years, particularly preferably more than 20 years.

A particular object was that the film composite for solar reflectors remain stable for a long time when subject to particularly strong insolation, as occurs by way of example in the Sahara or in the south west of the USA. This particularly affects the intrinsic stability and filter efficiency of the outer film of said composite films with respect to the UV wavelength spectrum from 300 nm to 400 nm.

Another object was to provide a film composite for solar reflectors, where the production of, and downstream operations on, these are simple and cost-efficient.

A further intention is that the increased-stability film composite have minimum colour and maximum resistance to moisture.

A further intention is that the film composite be scratch-resistant and have dirt-repellent properties.

### ACHIEVEMENT OF OBJECT

In the light of the prior art and the shortcomings of the technical solutions described therein for long-term applications, the present invention is successful in a manner which was not readily foreseeable by the person skilled in the art in providing a film composite which is transparent except for the metal layer and which has improved weathering resistance and provides good and stable solar reflection over a long period, and which also has a number of further advantages.

The object is achieved via provision of a novel film composite which can be used in solar reflectors. Said film composite is composed of at least the following layers: an outer film, a backing film, a metal layer, and a pressure-sensitive-adhesive layer. In particular, this is a film composite in which the outer film is a PMMA-based film, the backing film is a polyester film, and the metal layer is a silver layer. Below the outer film there is also optionally an adhesive layer applied, and below the metal layer there is also optionally a migration-barrier layer and/or a primer applied.

Said film composite is preferably composed of at least the following layers, in the sequence listed, from the subsequent external side to the PSA layer, which is bonded to a backing material: an outer film, a backing film, a metal layer, and a pressure-sensitive-adhesive layer. Between the outer film and the backing film there is also optionally an adhesive layer applied, and between the metal layer and the pressure-sensitive adhesive there is also optionally a migration-barrier layer and/or a primer applied.

Another important feature of the present invention is that the novel film composite features very high stability, in particular UV resistance, even when subject to prolonged irradiation. To this end, the outer film comprises at least one triazine as UV absorber, and one UV stabilizer. In particular, a mixture of UV absorbers is involved, composed of at least one triazine and of at least one benzotriazole. The UV stabilizer is a HALS compound or a mixture of various HALS compounds. Triazine-based UV absorbers exhibit particularly high intrinsic stability when exposed to UV radiation.

Stability is the intrinsic stability of the outer film with respect to UV effects and weathering effects, and at the same time the stability of the UV-protection effect, discernible by way of example from maintenance of solar reflection.

The outer film can preferably comprise from 0.1% to 10% by weight, preferably from 0.2% by weight to 6% by weight, and particularly preferably from 0.5% by weight to 4% by weight, of the benzotriazole-type UV absorbers,

from 0.1% to 5% by weight, preferably from 0.2% to 3% by weight, and particularly preferably from 0.5% by weight to 3% by weight, of the triazine-type UV absorbers, and

from 0.1% by weight to 5% by weight, preferably from 0.5% by weight to 3% by weight, and particularly preferably from 0.2% by weight to 2% by weight, of the UV stabilizers, preferably HALS-type UV stabilizers.

The mixture used according to the invention and composed of UV absorbers and of UV stabilizers exhibits stable, durable UV protection over a wide wavelength spectrum (from 300 nm to 400 nm).

The outer film, comprising the mixture composed of UV stabilizers and of UV absorbers, can optionally be composed of poly(meth)acrylate and polyvinylidene fluoride in a ratio by weight of from 1:0.01 to 1:1, preferably from 1:0.1 to 1:0.5. It is preferable that the outer film encompasses two sublayers. One sublayer here is a sublayer composed of poly(meth)acrylate and the other is a sublayer composed of polyvinylidene fluoride (PVDF). It is preferable that the PVDF sublayer is the layer located at the surface of the film composite.

Irrespective of the composition, the thickness of the outer film is in the range from 10 μm to 200 μm, preferably in the range from 40 μm to 120 μm, particularly preferably in the range from 50 μm to 90 μm.

The outer film used according to the invention has optionally been rendered scratch-resistant, preferably by virtue of a scratch-resistant coating. The surface of the outer film can moreover have been equipped with an antisoiling coating.

The novel film composite according to the invention moreover has a combination of the following properties as advantage over the prior art, particularly in respect of optical properties: the transparent part of the film composite according to the invention has particularly little colour and does not become cloudy when exposed to moisture. The film composite also exhibits excellent weathering resistance and, if equipped optionally with a PVDF surface and/or if rendered scratch-resistant, has very good chemicals resistance, for example with respect to any commercially available cleaning composition. These are further aspects contributing to maintenance of solar reflection over a long period.

To facilitate cleaning, the surface has dirt-repellent properties. The surface is also optionally abrasion-resistant and/or scratch-resistant.

The film composite according to the invention is used in particular as reflector film in solar reflectors. The reflector film is applied to a metal backing sheet, for example an aluminium sheet, by means of film lamination, and the adhesion to the metal backing sheet is brought about by the pressure-sensitive-adhesive layer.

The film composite according to the invention in particular features UV resistance markedly improved over the prior art, and the longer lifetime associated therewith. The material according to the invention can therefore be used in solar reflectors over a very long period of at least 10 years, indeed preferably at least 15 years, and particularly preferably at least 20 years, at locations with a particularly large number of hours of sunlight and with particularly intensive insolation, examples being the south-west of the USA and the Sahara.

The maximum decrease in solar reflection of the durable solar reflector equipped with the film composite according to the invention over a period of 10 years is 8%, preferably 5%, and particularly preferably 3%.

### DETAILED DESCRIPTION OF THE INVENTION

The outer films ideally used for UV protection of the reflector film composites structured according to the invention correspond to the UV-protective films disclosed in WO 2007/073952 (Evonik Röhm) or DE 10 2007 029 263 A1. These films can, by way of example, have the constituents briefly outlined hereinafter. A more comprehensive description is found in WO 2007/073952. The outer films used according to the invention are PMMA-based films. The wording PMMA-based films does not, however, restrict the films to straight methacrylate compositions or to a single-layer structure. Instead of this, the PMMA in the films can comprise comonomers which are not methacrylates. The films can also be composed of blends of various plastics, and it is not necessary that all of these contain methacrylates. The films can also comprise a polybutyl acrylate elastomer fraction for impact-modification. The outer film can moreover be composed of more than two layers. It is not essential that all of these layers comprise methacrylates.

### Production of the PMMA Plastics

Polymethyl methacrylate plastics are generally obtained by free-radical polymerization of mixtures which comprise methyl methacrylate. These mixtures generally comprise at least 40% by weight, preferably at least 60% by weight and particularly preferably at least 80% by weight, based on the weight of the monomers, of methyl methacrylate.

These mixtures for production of polymethyl methacrylates can also comprise other (meth)acrylates copolymerizable with methyl methacrylate. The expression (meth)acrylates comprises methacrylates and acrylates and mixtures of the two. These monomers are well known.

The compositions to be polymerized can also comprise, as well as the (meth)acrylates described above, other unsaturated monomers which are copolymerizable with methyl methacrylate and with the abovementioned (meth)acrylates. Among these are, inter alia, 1-alkenes, such as 1-hexene, acrylonitrile; vinyl esters, such as vinyl acetate; styrene or a-methylstyrene. The amount generally used of these comonomers is from 0% by weight to 60% by weight, preferably from 0% by weight to 40% by weight, and particularly preferably from 0% by weight to 20% by weight, based on the weight of the monomers, and these compounds can be used individually or in the form of a mixture.

The outer films used according to the invention also have major advantages in production. The components used, e.g. the UV stabilizers and the UV absorbers, permit economic operation of an extrusion plant. By way of example, no gases are evolved during the film extrusion process. There is therefore no need for complicated purging processes that are detrimental to quality.

Impact-Modified poly(meth)acrylate

The PMMA-based film used according to the invention can comprise impact modifiers. A more detailed description of these impact modifiers is also found in WO 2007/073952.

### PMMA/PVDF Films

In one particular embodiment of the invention, it is also possible to use PMMA/PVDF films as outer film instead of straight methacrylate films. PVDF (polyvinylidene fluoride) has some advantages as constituent of a polymer blend or as laminate: PVDF has high chemicals resistance and low surface energy. PVDF is therefore water-repellent and is comparable with biocidal materials in that, even in long-term use, it is highly resistant to colonization by organisms.

It is also possible to achieve high transparency in very thin PVDF layers of thickness from 1 μm to 10 μm, preferably from 2 μm to 5 μm. A detailed description of the production of PMMA/PVDF films is found in DE 10 2007 029 263 A1.

The PMMA/PVDF films can be produced in the form of monofilms (produced by chill-roll processes) or in the form of films having more than one sublayer (produced by means of lamination of two films or coextrusion of the corresponding layers of melt), and both variants here can achieve all of the advantages mentioned for the product. The UV stabilizers and/or UV absorbers can be present here in one or both of the films.

The ratio of poly(meth)acrylate to polyvinylidene fluoride, both in monofilms and in films having more than one sublayer, is in the range from 1:0.01 to 0.3:1 (based on weight). Even more preference is given to modifications in which the film encompasses a mixture of poly(meth)acrylate and polyvinylidene fluoride in a ratio of from 1:0.1 to 0.4:1.

The PVDF polymers used for the purposes of the invention are polyvinylidene fluorides, i.e. generally transparent, semicrystalline, thermoplastic fluoroplastics. The fundamental unit for polyvinylidene fluoride is vinylidene fluoride, which is reacted (polymerized) in ultra-pure water under controlled conditions of temperature and pressure by means of a specific catalyst to give polyvinylidene fluoride. Vinylidene fluoride is in turn available by way of example from hydrogen fluoride and methylchloroform as starting materials, by way of chlorodifluoroethane as precursor. For the purposes of the invention, very successful results can be obtained in principle by using any of the PVDF grades marketed. Among these are, inter alia, Kynar® grades produced by Arkema, Dyneon® grades produced by Dyneon and Solef® grades produced by Solvay.

### The Stabilizer Package (Light Stabilizer)

A particular constituent of the UV-protective films used according to the invention is the UV-stabilizer package, and this will be described in more detail below.

Light stabilizers are well known, and are described in detail by way of example in Hans Zweifel, Plastics Additives Handbook, Hanser Verlag, 5th Edition, 2001, pp. 141 ff. Light stabilizers are UV absorbers, UV stabilizers and free-radical scavengers. It is therefore possible to select UV absorbers by way of example from the group of the substituted benzophenones, salicylates, cinnamates, oxanilides, benzoxazinones, hydroxyphenylbenzotriazoles, triazines, and benzylidenemalonate.

The best known representative of the UV stabilizers/free-radical scavengers is the sterically hindered amines group (hindered amine light stabilizer; HALS).

The stabilizer package used in the films used according to the invention is composed of the following components:
Component A: a benzotriazole-type UV absorber,
Component B: a triazine-type UV absorber,
Component C: a UV stabilizer, preferably a HALS compound.

Components A and B can be used as a single substance or in a mixture. At least one UV-absorber component must be present in the film. Component C is essential in the film used according to the invention.

### Component A: Benzotriazole-Type UV Absorber

Examples of UV absorbers of benzotriazole type that can be used are 2-[2-hydroxy-5-methylphenyl)benzotriazole, 242-hydroxy-3,5-di(alpha,alpha-dimethylbenzyl)phenyl]benzotriazole, 2-(2-hydroxy-3,5-di-tert-butyl-phenyl)benzotriazole, 2-(2-hydroxy-3,5-butyl-5-methylphenyl)-5-chloro-benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-butyl-phenyl)benzotriazole, 2-(2-hydroxy-3-sec-butyl-5-tert-butylphenyl)benzotriazole and 2-(2-hydroxy-5-tert-octylphenyl)benzotriazole, phenol, 2,2′-methylenebis[6-(2H-benzotriazol-2-yl)-4-(1,1,3,3-tetramethylbutyl)].

The amounts used of the UV absorbers of benzotriazole type are from 0.1% by weight to 10% by weight, preferably from 0.2% by weight to 6% by weight and very particularly preferably from 0.5% by weight to 4% by weight, based on the weight of the monomers used to prepare the polymethyl methacrylates. It is also possible to use mixtures of different UV absorbers of benzotriazole type.

### Component B: Triazine-Type UV Absorber

Triazines, such as 2-(4,6-diphenyl-1,3,5-triazin-2-yl)-5-hexyloxyphenol, can moreover also be used as UV stabilizers in the mixture.

The amounts used of the triazines are from 0.0% by weight to 5% by weight, preferably from 0.2% by weight to 3% by weight and very particularly preferably from 0.5% by weight to 2% by weight, based on the weight of the monomers used to prepare the polymethyl methacrylates. It is also possible to use mixtures of different triazines.

### Component C: UV Stabilizers

An example which may be mentioned here for free-radical scavengers/UV stabilizers is sterically hindered amines, known as HALS (Hindered Amine Light Stabilizer). They can be used to inhibit ageing phenomena in paints and plastics, especially in polyolefin plastics (Kunststoffe, 74 (1984) 10, pp. 620-623; Farbe+Lack, Volume 96, 9/1990, pp. 689-693). The tetramethylpiperidine group present in the HALS compounds is responsible for the stabilizing effect. This class of compound can have no substitution on the piperidine nitrogen or else substitution by alkyl or acyl groups on the piperidine nitrogen. The sterically hindered amines do not absorb in the UV region. They scavenge free radicals that have been formed, whereas the UV absorbers cannot do this. Examples of HALS compounds which have stabilizing effect and which can also be used in the form of mixtures are: bis(2,2,6,6-tetramethyl-4-piperidyl) sebacate, 8-acetyl-3-dodecyl-7,7,9,9-tetramethyl-1,3,8-triazaspiro(4,5)-decane-2,5-dione, bis(2,2,6,6-tetramethyl-4-piperidyl) succinate, poly(N-β-hydroxyethyl-2,2,6,6-tetramethyl-4-hydroxypiperidine succinate) or bis(N-methyl-2,2,6,6-tetramethyl-4-piperidyl) sebacate.

The amounts used of the HALS compounds are from 0.0% by weight to 5% by weight, preferably from 0.1% by weight to 3% by weight and very particularly preferably from 0.2% by weight to 2% by weight, based on the weight of the monomers used to prepare the polymethyl (meth)acrylates. It is also possible to use mixtures of different HALS compounds.

Other costabilizers that can be used moreover are the HALS compounds described above, disulphites, such as sodium disulphite, and sterically hindered phenols and phosphites.

### The Adhesive Layer

As a function of the production process, the optional adhesive layer serves for bonding of the outer film to the backing film. It is present only when direct adhesion between the two films is not possible. The selection of the appropriate adhesive depends on the composition of the two films—for example PMMA and PET—and on optical properties. The adhesive layer, too, must have high transparency. Specific acrylate adhesives can be suitable, for example.

### The Scratch-Resistant Coating

The expression scratch-resistant coating in the context of this invention is a collective term for coatings which are applied in order to reduce surface scratching and/or to improve abrasion resistance. High abrasion resistance is of particularly high importance for the use, according to the invention, of the film composites in solar reflectors.

Another important property of the scratch-resistant coating in the widest sense is that said layer does not adversely affect the optical properties of the film composite.

The scratch-resistant coating used can comprise polysiloxanes, such as CRYSTALCOAT™MP-100 from SCD Technologies Inc., AS 400-SHP 401, or UVHC3000K, both from Momentive Performance Materials. These coating formulations are applied by way of example by way of roller coating, knife coating, or flow coating, to the surface of the film composite or of the outer film.

Examples that may be mentioned of other coating technologies that can be used are PVD plasma (physical vapour deposition; physical gas-phase deposition) and CVD plasma (chemical vapour deposition; chemical gas-phase deposition).

### The Backing Film

The selection of the backing film is determined by the following essential properties: the film must be a high-transparency, flexible, heat-resistant film that can be metallized with a thin metal layer. To this end, the metal layer should exhibit no loss of adhesion over a long period. Films that have proved to have this type of property profile are in particular polyester films, and very particularly coextruded, biaxially oriented polyethylene terephthalate films (PET). These have optionally been equipped with adhesion promoters to improve adhesion of the metal layer, surface-finishing layer, or, respectively, adhesive layer. The backing films used can also alternatively comprise PMMA films, two-layer PVDF/PMMA films, or films composed of PVDF/PMMA blends.

### The Metal Layer

The metal layer is preferably applied to the reverse side of the backing film and is preferably composed of silver or aluminium, particularly preferably of silver. On the side facing away from the backing film, the metal layer can optionally be covered with a second metal layer, for example composed of copper or of a nickel-chromium alloy. This then serves firstly to protect the metal reflector layer and secondly to improve the adhesion of the pressure-sensitive-adhesive layer. As an alternative to silver, aluminium is used as metal for the reflector layers. It is preferable here that the layers known as “enhancement stack” layers are applied (by means of physical vapour deposition) to raise the comparatively “low” reflection level of the aluminium reflector in the relevant wavelength range.

As an alternative to use in the film composite described, the outer films used according to the invention can also be used for surface finish or, respectively, to improve the weathering-protection provided to multilayer aluminium-strip-based systems such as those marketed as MIRO-SUN® by Alanod solar.

### Particular Embodiment

In one particular embodiment, a metal-layer system is used in the form of a metal strip, preferably based on aluminium, an example being MIRO-SUN®; this serves simultaneously as backing film. The backing film and the metal layer are therefore identical in this embodiment, and there is no need for any further polymer-based backing film.

### The Pressure-Sensitive-Adhesive Layer

The pressure-sensitive-adhesive layer serves for the adhesive bonding of the film composite for example to a backing material, e.g. a curved aluminium sheet. The selection of the pressure-sensitive adhesive (PSA) is determined via the adhesion with respect to said backing material and with respect to the reverse side of the metal coating. For protection of the metal coating it would also be advantageous that the pressure-sensitive-adhesive layer has only low permeability to atmospheric oxygen and water vapour.

For the purposes of transport and storage, the pressure-sensitive-adhesive layer is applied to a siliconized paper. It can in turn easily be removed prior to adhesive bonding to the backing material.

### Migration-Barrier Layer and Primer

Materials used as migration barrier inhibit migration of constituents damaging to the metal layer, e.g. atmospheric oxygen, water vapour, or else constituents that can migrate from the pressure-sensitive adhesive. By way of example, this can be an epoxy-resin layer.

The selection of, and the need for, a primer is determined by the adhesion properties or surface properties of the metal layer and of the pressure-sensitive adhesive used.

### Alternative Film-Composite Structure

As an alternative to the layer sequence described above for the film composite systems according to the invention, composed—from the outside to the inside—of an optional scratch-resistant coating, an optional dirt-repellent coating, an outer film, an optional adhesive layer, a backing film, the metal layer, an optional primer and/or migration-barrier layer, and a pressure-sensitive adhesive, the film composite can also be composed of the following, again in the following layer sequence—from the outside to the inside:
scratch-resistant coating and/or dirt-repellent coating (optional)
outer film
adhesive layer (optional)
metal layer
primer and/or migration barrier
backing film
pressure-sensitive adhesive

### Production of Film Composite

As a function of intended use, the outer film used according to the invention in the form of monofilm or film having more than one sublayer can be produced with any desired thickness. A decisive factor here is always the high transparency of the outer film, coupled with exceptional weathering resistance, and also with the extremely high level of weathering protection provided to the substrate.

The single- or multilayer outer film is produced via methods known per se, an example being extrusion through a flat-film die, blown-film extrusion, or solution casting.

Examples of methods for producing the film composite are lamination and/or (co)extrusion coating.

1. A film composite for a solar reflector, comprising:
an outer film comprising a triazine, as a UV absorber, and a UV stabilizer;
a backing film;
a metal layer; and
a pressure-sensitive adhesive.

2. The film composite of claim 1, comprising, in sequence;
an outer film comprising a triazine, as a UV absorber, and a UV stabilizer;
a backing film;
a metal layer; and
a pressure-sensitive adhesive.

3. The film composite of claim 1,
wherein the outer film is a PMMA-based film,
the backing film is a polyester film, a PMMA film, a two-layer PVDF/PMMA film, or a PVDF/PMMA blend film, and
the metal layer is a silver layer or an aluminum layer.

4. The film composite of claim 1,
wherein the backing film and the metal layer are comprised in a metal-based layer.

5. The film composite of claim 1, further comprising:
an adhesive layer between the outer film and the backing film or between the outer film and the metal layer.

6. The film composite of claim 1, wherein the outer film comprises:
a mixture of UV absorbers, comprising a triazine and a benzotriazole, and
a HALS compound as a UV stabilizer.

7. The film composite of claim 6, wherein the outer film comprises:
from 0.1% by weight to 10% by weight of the benzotriazole,
from 0.1% by weight to 5% by weight of the triazine UV absorber, and
from 0.1% by weight to 5% by weight of the HALS compound.

8. The film composite of claim 1,
wherein the outer film comprises poly(meth)acrylate and polyvinylidene fluoride in a ratio by weight of from 1:0.01 to 0.3:1, and
the outer film further comprises a UV stabilizer, a UV absorber, or a mixture thereof.

9. The film composite of claim 8, wherein the outer film comprises:
a first sublayer comprising poly(meth)acrylate and
a second sublayer comprising polyvinylidene fluoride.

10. The film composite of claim 1, wherein the outer film is scratch-resistant.

11. The film composite of claim 1, wherein a surface of the outer film comprises an antisoiling coating.

12-13. (canceled)

14. A solar reflector with long service life, comprising the film composite of claim 1, wherein a solar reflection decreases by at most 8% over a period of 10 years.

15. The film composite of claim 3, wherein the metal layer is a silver layer.

16. The film composite of claim 4, wherein the backing film and the metal layer are comprised in an aluminum-based layer.

17. The film composite of claim 7, wherein the outer film comprises:
from 0.5% by weight to 4% by weight of the benzotriazole,
from 0.5% by weight to 3% by weight, of the triazine, and
from 0.2% by weight to 2% by weight, of the HALS compound.

18. The film composite of claim 1, wherein the outer film comprises poly(meth)acrylate and polyvinylidene fluoride in a ratio by weight of from 1:0.1 to 0.4:1.

19. The film composite of claim 10, wherein the outer film comprises a scratch-resistant coating.

20. A method of producing a solar reflector, comprising producing a solar reflector with the film composite of claim 1.

21. The method of claim 20, wherein producing the solar reflector comprises:
applying the film composite, via the pressure-sensitive adhesive, to a metal backing sheet, by film lamination.

22. The solar reflector of claim 14, wherein the solar reflection decreases by at most 5% over a period of 10 years.
